(19) United States
(12) Patent Application Publication
(10) Pub. No.: US 2026/0220051 A1
(43) Pub. Date: Jul. 30, 2026

(54) USING MASKED STREAM IDENTIFIERS FOR A TRANSLATION LOOKASIDE BUFFER

(71) Applicant: Google LLC, Mountain View, CA (US)

(72) Inventors: Kiran Srinivasa Sastry, Santa Clara, CA (US); Yanru Li, San Diego, CA (US); Thomas Mengtao Zeng, San Diego, CA (US)

(21) Appl. No.: 19/140,287

(22) PCT Filed: Dec. 22, 2022
(86) PCT No.: PCT/US2022/082246

§ 371 Date: Jun. 17, 2025

(51) Int. Cl. G06F 12/1027

(52) U.S. Cl. CPC G06F 12/1027

(57) ABSTRACT

Methods, systems, and apparatus, including computer programs encoded on computer storage media, for a translation lookaside buffer to use stream id masking. A system includes a translation lookaside buffer unit configured to map an input translation request to a physical address, in which each input translation request includes a virtual address and stream id. The system further includes stream id masking logic that is configured to mask the stream id of related input translation requests, generating a masked translation request. Each masked translation request includes a virtual address and masked stream id, in which the translation lookaside buffer services the input translation request using the masked translation request.

### BACKGROUND

This specification relates to systems having integrated circuit devices.

A cache is a device that stores data retrieved from memory or data to be written to memory for one or more different hardware devices in a system. The hardware devices can be different components integrated into a system on a chip (SOC). In this specification, the devices that provide read requests and write requests through caches will be referred to as client devices.

A translation lookaside buffer (TLB) is a specialized cache for storing address translations, and may also include attributes configurations. A page table is a data structure in memory that stores mappings between virtual addresses generated by software applications and physical addresses that identify actual physical memory locations. The page table may also include the memory access attributes, e.g., security domain, coherence indication. Whenever an address translation is fetched from the page table, the translation mapping can be cached in a TLB. Thus, the next time the translation is needed, the mapping can be retrieved from the TLB rather than accessing memory. Modern TLB systems often have multiple layers of caching.

Modern TLB systems can also segregate streams of translation requests to improve security and data isolation. In this specification, a stream is a set of related translation requests. The translation requests can be related in a number of ways depending on design choices of the system. For example, a TLB can consider streams to be related when they originate from the same software application, from the same client device, or some combination of these. Alternatively or in addition, a TLB can consider streams to be related due to being translations for addresses storing instructions versus addresses storing data.

To segregate streams of translation requests, a TLB can be designed to associate each translation entry with its stream identifier (SID). For an entry to be considered a TLB hit according to an architecture specification, both the virtual address of an incoming translation request and the SID of the incoming translation request must match the data in an entry of the TLB. Thus, if the SID for an incoming translation request does not match the SID for a TLB entry having an otherwise matching virtual address, the translation request will result in a TLB miss, which means that the TLB must therefore seek the translation in lower TLB levels or from the page table all the way out in memory.

However, in some situations, using stream ids to match TLB entries results in massively redundant TLB entries. For example, modern client devices can have multiple cores or processing elements that work closely together to perform a particular task. One such example is a machine learning accelerator that has multiple cores for parallelizing machine learning operations, e.g., two-dimensional convolutions. When the requests from the individual processing cores are treated as belonging to different streams, a device having N cores can result in the same address translation occupying N entries in the TLB, with each entry storing a redundant translation for a different stream ID. This might happen, for example, if all cores seek to fetch the same weight of a particular convolution kernel. In that case, the translation for the physical address of the weight can end up occupying up to N TLB entries.

Redundant TLB entries reduce device performance because they increase the TLB miss rate and cause more round trips to memory. One way of mitigating the problem is to make the TLB larger. But in order to have a TLB serving an N-core device match the TLB performance of a one-core device, the size of the TLB would have to be increased by a factor of N, which greatly increases the complexity, cost, silicon area, and power consumption of the resulting device.

### SUMMARY

This specification describes a translation lookaside buffer (TLB) system that uses stream ID masking. The TLB system can use stream ID masking logic to generate masked stream ids and can then use the masked stream ids in determining whether a translation request has a valid TLB entry. The stream ID masks are highly configurable and need not be applied to every stream. Therefore, the TLB system can selectively apply stream ID masking to achieve the security benefits of stream ID segregation while also solving the problem of redundant TLB entries for related streams.

Particular embodiments of the subject matter described in this specification can be implemented so as to realize one or more of the following advantages.

A TLB can increase performance and utilization by using stream ID masking on translation requests for related streams. Therefore, the TLB can reduce competition for TLB entries for different streams of translation requests, which increases the TLB hit rate. Increasing the TLB hit rate decreases power consumption and extends battery life in mobile devices that rely on battery power.

A TLB system using stream ID masking can be less expensive compared to a TLB system that does not use stream ID masking. This is because stream ID masking reduces the number of redundant TLB entries. For example, a client device with N cores performing complex computations, e.g., two-dimensional convolution, may create N entries in a TLB if each core requests the same weight of a convolution kernel. The client device may perform thousands of convolutions based on operational parameters such as data input size, number of layers, kernel size, etc. As the number of operational parameters increase, the number of convolutions can grow exponentially and increase computation time. Without stream ID masking, a more expensive TLB system with greater memory specification e.g., larger memory systems, is required to complete the computation task compared to a smaller TLB system with stream ID masking. Additionally, a TLB system utilizing stream ID masking can reduce the computation complexity compared to the TLB system without stream ID masking. By reducing the number of TLB misses and page table walks, the TLB system utilizing stream ID masking can perform the same computation as the TLB system without stream ID masking in less time. Moreover, given the same amount of time, the TLB system utilizing stream ID masking can perform more computations compared to the TLB system without stream ID masking.

As another advantage, a TLB system utilizing stream ID masking will require less silicon, e.g., smaller integrated circuit dimensions, in a corresponding memory management unit compared to the silicon required in a memory management unit with a TLB system that does not perform stream ID masking. As an example, a memory management unit and TLB system without stream ID masking may perform computations for a client device and result in extraneous TLB misses and page walks. A memory management unit with a TLB system utilizing stream ID masking can perform the same computations for the client device with fewer TLB misses and page walks, and therefore utilize a smaller portion of available silicon. Due to the relatively expensive manufacturing costs of silicon, utilizing smaller portions of silicon can be a significant cost savings in producing SoC devices.

Yet another advantage of a TLB system utilizing stream ID masking is the increased performance and power savings compared to a TLB system without stream ID masking. Relative to a TLB system without stream ID masking, a TLB system that uses stream ID masking generates fewer redundant TLB entries and page walks. Redundant TLB entries and page walks consume additional power for a client device, with a drastic impact as the number of cores increase for the client device. By utilizing a TLB system and stream ID masking, the extraneous TLB entries and page walks can be avoided and therefore the client device consumes less power by operating with less time. Additional power and time savings can be utilized for additional tasks, including high complexity tasks such as computations involving operands for a machine-learning workload.

Relative to a TLB system without stream ID masking, the disclosed stream ID masking techniques of an improved TLB system can enable the client device to deliver better performance. For example, a client device that includes the improved TLB system can perform its computations with lower latency, shorter processor time, and/or a higher number of instructions per second.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system that uses stream ID masking.

FIG. 2 is an example process for servicing and assigning masks for input translation requests, according to implementations of the present disclosure.

FIG. 3 is a flowchart of an example process for servicing an input translation request, according to implementations of the present disclosure.

FIG. 4 is a flowchart of an example process for servicing a change in the page table, according to implementations of the present disclosure.

Like reference numbers and designations in the various drawings indicate like elements.

### DETAILED DESCRIPTION

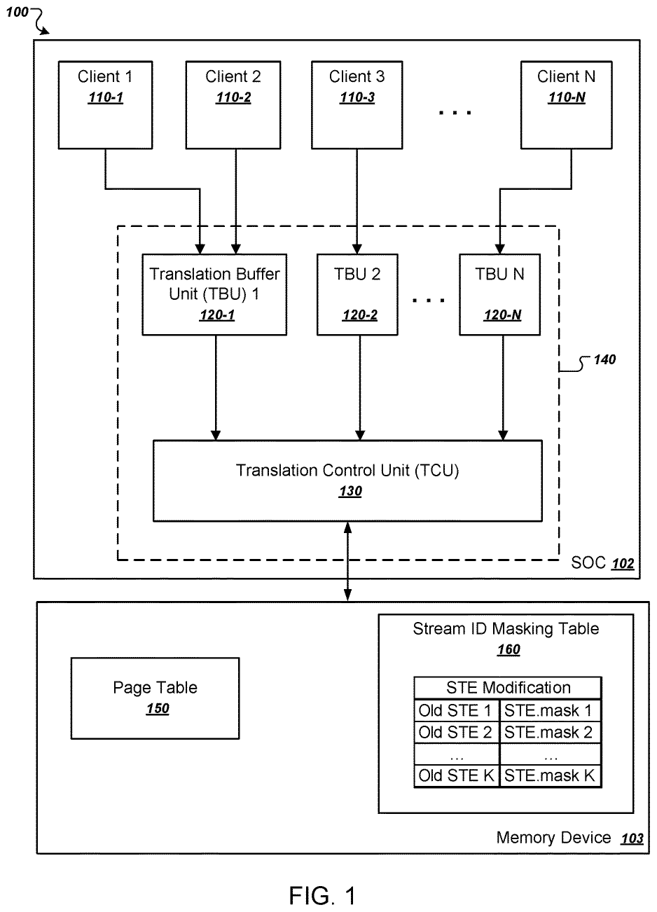

FIG. 1 illustrates an example system 100 that uses stream ID masking. The system 100 includes a system on a chip (SOC) 102 communicatively coupled to a memory device 103. The SOC 102 includes one or more client devices 110-1-110-N that use a translation subsystem 140 to manage and cache address translations. The translation subsystem 140 FIG. includes translation buffer units (TBU) 120-1-120-N to provide address translations for the client devices 110-1-110-N and a translation control unit (TCU) 130 to perform page table walks when mappings for TLB misses in the TBUs 120-1-120-N. When performing a page table walk, the TCU 130 accesses a page table 150 of page table entries, e.g., mappings between virtual address and physical addresses, on memory device 103.

A stream ID (SID) masking table 160 is stored on memory device 103, and is used to provide the translation subsystem 140 with masks for translations with related SIDs. In some implementations, a single TBU 120 may be used to provide translations to the client devices 110-1-110-N. In some implementations, a client device may access multiple TBUs and multiple client devices may access the same TBU, e.g., any number of client devices can be serviced by any appropriate number of TBUs. In some implementations, a SID masking table may be used to provide masks for translation systems in other kinds of computer architectures.

The SOC 102 is an example of a device that can be installed on or integrated into any appropriate computing device. Because the translation caching techniques described in this specification are particularly suited to saving power consumption for the host device, the SOC 102 can be particularly beneficial when installed on a mobile host devices that rely on battery power, e.g., a smart phone, a smart watch or another wearable computing device, a tablet computer, or a laptop computer, to name just a few examples.

The client devices 110-1-110-N can be any appropriate computing device, e.g., processor cores, external interfaces, and graphical processing units, to name just a few examples.. An example client device includes a processor core, e.g., a digital signal processor or a microcontroller.. The client devices 110-1-110-N can generate input translation requests to perform tasks, e.g., running software applications.

The TBU 120 caches address translations between virtual and physical memory by attempting to map input translation requests to matching TLB entries storing corresponding physical addresses. Each input translation request includes a virtual address and a stream identifier (SID). The SID identifies one or more related input translation requests for a translation subsystem 140, in which the related input translation requests share the same SID.

If the mapping does not exist, e.g., a TLB miss, the TCU 130 can walk through the page table 150 in memory device 103 to determine the address translation for the corresponding input translation request. The page table is a data structure in memory having page table entries, with each page table entry containing a mapping between a virtual address and a physical address.

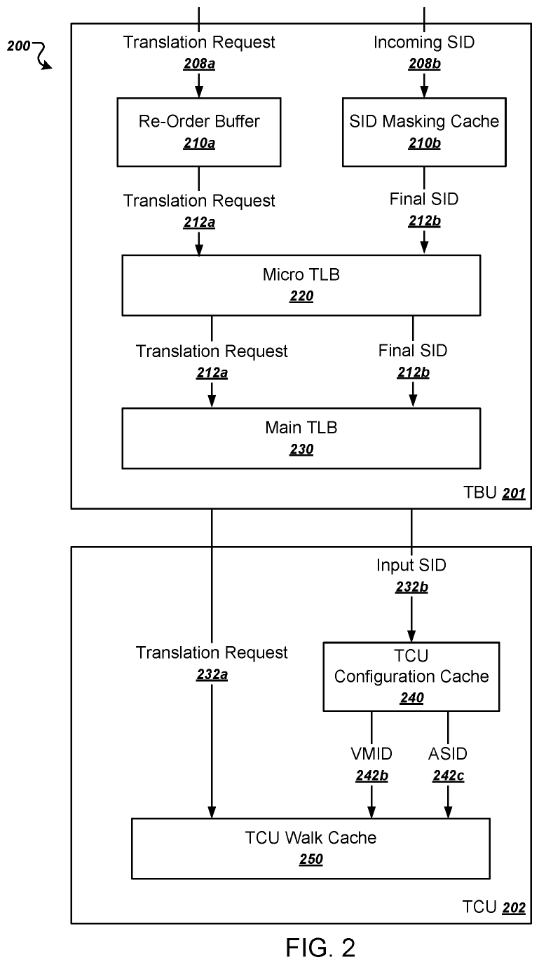

An SID masking table 160 is introduced, e.g., generated, accessed, in this process of masking stream IDs. The TCU 130 can also access an SID masking table 160 stored on memory device 103 to associate a mask for related SIDs from multiple input translation requests. The SID masking table 160 includes a stream table entry (STE) modification table, that stores attribute modifications for each stream ID entry. Example attribute modifications include designating a bit mask (e.g., clearing a number of bits), in which related stream table entries will have the same mask applied. The bit mask can be configured to selectively mask out some bits in the SID, or consider all the bits in the SID so that the SID is unmodified. The stream ID masking logic is further described below with reference to FIG. 2

By adding a masking attribute to the stream table entry, the TCU 130 can determine that multiple SIDs are related and therefore can use the same virtual to physical address mappings, despite possibly coming from different streams. The input translation requests shared across one or more client devices 110-1-110-N may originally be identified as unique, when they are in fact related. Uniquely identified input translation requests result in additional page table walks to perform address translations. Using the masking attribute of the SID masking table 160 allows the translation subsystem 140 to recognize when two or more input translation requests are masked similarly. This similar masking can indicate that the requests are therefore related and can be services that use the same translation instructions. When the TCU 130 performs page translation, the TCU 130 can retrieve the masking information for corresponding SIDs to demonstrate that the SIDs are related. The TCU 130 can then provide these associated and updated mappings to the TBU 120 for future use.

If two or more input translation requests are related, then the TCU 130 provides masking so that subsequent related input translation requests can find their mappings in the respective TBU 120-1-120-N or in the TCU, instead of revisiting the page table, e.g., in the event of a page miss. A respective TBU 120-1-120-N generates a masked translation request to be serviced if the respective input translation request includes an associated mask attribute (e.g., the input translation requests have related SIDs). The masked translation request provides the respective TBU 120-1-120-N with a related SID to perform the translation (e.g., using the mapping of the related SID). Otherwise, the respective TBU 120-1-120-N continues to service the input translation request by performing a lookup between cached virtual and physical address mappings.

FIG. 2 is a diagram of an example translation subsystem 200 (e.g., the translation subsystem 140 of FIG. 1) with parallel circuitry to process an input translation request (e.g., including masked translation requests) to reduce or mitigate the latency impact of the SID masking logic. The translation subsystem 200 includes a TBU 201 and a TCU 202, in which both the TBU 201 and TCU 202 are configured to implement the parallel circuitry upon receipt of an input translation request. In some implementations, the translation subsystem 200 can include multiple instances of a TBU 201 and a TCU 202, respectively. In this example, the parallel circuitry of the TBU 201 includes components that can operate concurrently for the same input translation request: performing a lookup in re-order buffer (ROB) 210a, and applying stream ID masking using an SID masking cache 210b storing data derived from an SID masking table, e.g., a stream ID masking table 160, of FIG. 1. In some implementations, the re-order buffer 210a may be referred to as a write data buffer or a write reorder buffer. In some implementations, the re-order buffer 210a may be an optional buffer provided for processing input translation requests. In some examples, the translation subsystem 200 processes an input translation request without performing stream ID masking (e.g., when it is unnecessary to apply a mask to the stream). In some implementations, additional processes are performed in addition to performing a lookup in ROB 210a and applying stream ID masking.

The TBU 201 receives an input translation request 208a associated with a memory transaction (e.g., received from a process of a client device). The translation request 208a can include a virtual address in addition to other configuration information. For example, the translation request 208a can be a request having multiple channels in the ACE5-Lite protocol.

The ROB 210a receives the translation request 208a and can generate a re-ordered translation request 212a to ensure that translations having an ordering have the same ordering when they exit the TLB subsystem 200. The ROB 210a is an optional component, but when it is used, the re-ordering logic takes some time to complete. Therefore, the translation subsystem 200 can, during this time, perform stream id masking in parallel, often without incurring any latency overhead.

Concurrently operating with the ROB 210a, the SID masking cache 210breceives the incoming SID 208b containing the stream ID of the input translation request. The SID masking cache 210b then generates a final SID 212b that is the result of applying a stream id mask to the incoming SID 208b. The SID masking cache 210b can store masks and then apply the mask itself, e.g., using integrated logic circuitry.

Alternatively or in addition, the SID masking cache 210b can store previously generated final SIDs. As one example, the final SIDs can be precomputed by the TCU 202.

The SID masks can be applied to any appropriate portion of the stream id. In a common scenario, streams that have been designated as related by the system have consecutively numbered stream ids. Therefore, associating the stream ids together with a mask can be accomplished using a mask on the least-significant bits (LSBs) of the stream id.

The microTLB 220 services the masked input translation request upon receiving the re-ordered translation request 212a and the final SID 212b, both corresponding to the masked input translation request. The micro TLB 220 (uTLB) performs lookups of virtual addresses to physical address mappings as a first level of caching in the TBU 201 system. The micro TLB 220 returns a physical address for the virtual address of the final SID 212b. If the micro TLB does not return an address, then a microTLB miss occurs and the translation subsystem 200 processes the input translation request by utilizing the next level of caching in the main TLB 230.

The main TLB 230 (mTLB) is the second level of caching in the example TBU 201 system that handles misses from the micro TLB. Thus, on a microTLB miss, the main TLB 230 receives the re-ordered translation request 212a and the final SID 212b. The main TLB 230 performs a lookup of the mapping between the virtual address and the physical address. If there is a main TLB miss, the system can use the TCU to walk the page table to find the translation.

The TCU 202 receives the re-ordered translation request 232a and the original input SID 232b and can use this information to perform a page table walk to obtain the desired translation. The TCU walk cache 250 is a memory cache located on the TCU 202 that stores results of one or more page table walks.

The TCU 202 can also obtain information in the page table that defines which streams are related. The TCU 202 can perform this process at initialization time as part of an initial handshake between the TBU 201 and the TCU 202. The TCU 202 can then walk the page table to determine which stream ids are related. From this information, the TCU 202 can compute a stream id mask for those stream ids. For example, if four stream ids having consecutive stream ids are related as indicated by the page table data, the TCU 202 can generate a stream id mask that masks off the least significant two bits. The TCU 202 can then apply this stream id mask to generate pairs of initial stream ids and final stream ids.

The TCU 202 can store this information in the TCU configuration cache 240 and can also populate the SID masking cache 210b with this information. As described above, alternatively or in addition, the TCU 202 can store the stream mask itself in the SID masking cache 210b in the case that the TCU 201 will compute the final stream ids rather than simply obtaining them at translation request time.

When performing the initial stream id mask computation process, the TCU configuration cache 240 can transmit the VMID 242b and ASID 242c to the TCU walk cache 250 after identifying the corresponding page table walk. The VMID 242b identifies how TLB entries belong to each virtual machine, while the corresponding ASID 242c distinguishes memory pages with the same virtual address from one another. The VMID 242b allows for translations for multiple virtual machines to be simultaneously present in the micro TLB 220 and the main TLB 230. The VMID 242b and ASID 242c are used to store the page table walk in the TCU walk cache 250, to be later used for related input translation requests without generating new TLB misses (e.g., additional page table hits).

Upon a cache miss at the TCU configuration cache 240, the TCU configuration cache 240 obtains the SID masks (e.g., from memory device 103, by the SID masking table 160, referring to FIG. 1) for the input translation request with related streams, and provides the SID masks to the TBU 201. When changes to the page table (e.g., page table 160, referring to FIG. 1) occur, or when there is a miss in the SID masking cache 210b, the TCU configuration cache 240 can provide SID masks to the TBU 201 to perform masking on the input translation request, and the SID masking cache 210b save this information until the masking is invalidated, or the cache is power collapsed, e.g., to reduce leakage.

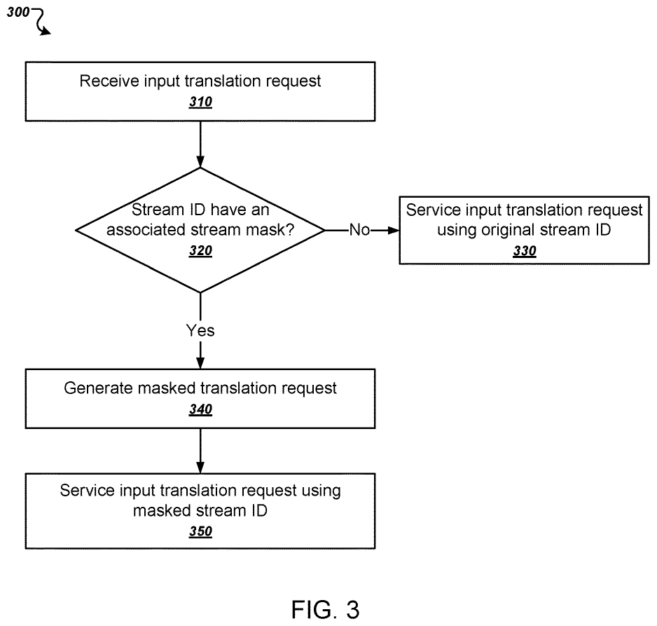

FIG. 3 is a flowchart of an example process for the TBU (e.g., TBU 120, referring to FIG. 1) servicing a received input translation request using masked stream ids.

The TBU receives an input translation request (310), which can be generated by a particular client device. In this example, the input translation request includes a virtual address and stream ID, which the TBU is configured to map to a physical address.

The TBU determines if the stream ID of the input translation request has an associated stream mask (320). For example, the TBU can check an SID masking cache to determine whether the incoming stream id has any entries in the SID masking cache.

If not, the input translation request is serviced using the original stream id (330). The TBU will service the input translation request by performing a look-up of the provided mappings between virtual and physical addresses. The TBU will provide the physical address associated to the virtual address of the input translation request. On a TLB miss, lower levels of TLB caching can be checked, or the page table itself, using the original stream id.

If the stream id does have an associated mask (320), the TBU generates a masked translation request (340). The masked translation request has a masked stream id, which, as described above, is commonly generated by clearing least-significant bits of the stream id. The TBU can either generate the masked stream id from a streak mask or can retrieve the masked stream id itself from the SID masking cache.

Once the masked translation request is generated, the TBU services the translation request using the masked stream id (350). As described above, using the masked stream id will on average result in a greater number of TLB hits because related stream ids that share virtual addresses can also share the same cached translations instead of all of them storing a separate copy.

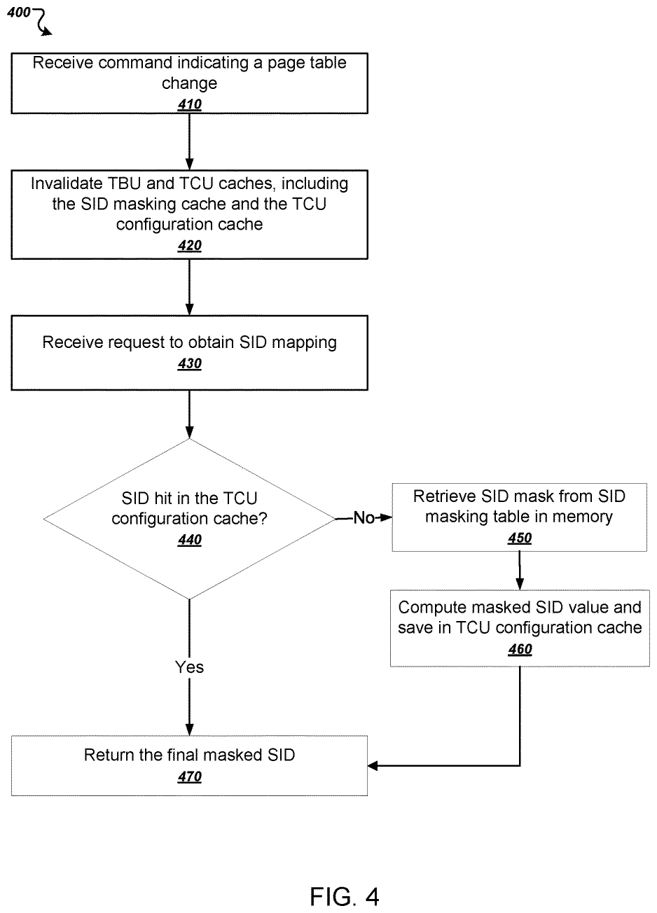

FIG. 4 is a flowchart of an example process for the TCU to populate the SID masking cache. The example process can be performed at any appropriate time when the SID masking cache needs to be updated. Typically this process occurs when changes to the page table occur, e.g., when a client device switches applications or execution contexts. The example process can also be performed when the device first starts up. The example process will be described as being performed by a TCU, e.g., the TCU 130 of FIG. 1.

The TCU receives a command indicating a page table change (410). The command can for example be a command that invalidates the page table, e.g., due to a change in the execution environment, or a command to start up the TCU configuration for the first time.

The TCU invalidates the TBU and TCU caches (420). In particular, the TCU can invalidate the SID masking cache, e.g., the SID masking cache 210b of FIG. 2, as well as the TCU config cache, e.g., the TCU configuration cache 240 of FIG. 2. Thereafter, the next request for a translation will result in a TLB miss as well as a TCU miss, and the TCU will have to read from the page table in memory to repopulate the TCU and TBU caches.

The TCU receives a request to obtain an SID mapping (430). The SID mapping is a mapping between an initial stream id and a masked stream id. The request can be a request from the TBU to check for a page table entry as a result of the TBU starting up or encountering a TBU miss.

The TCU determines whether there is an SID hit in the TCU configuration cache (440). In other words, the TCU can determine whether the TCU configuration cache has the mapping between the requested stream id and a masked stream id.

If not, the TCU can retrieve the SID mask from an SID masking table in memory (branch to 450). The TCU can then use the SID mask to compute the masked stream id, and the TCU can then save the mapping between the original stream ID and the computed masked stream id in the TCU configuration cache (460).

If the SID mapping did exist in the TCU configuration cache (440), or if the TCU just retrieved the SID mask and stored the mapping in the TCU configuration cache, the TCU can return the final masked SID in response to the request (470). As this process is repeated, the TCU and TBU will gradually work to build up SID mapping entries in their respective caches, until another page table change is detected.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

In addition to the embodiments described above, the following embodiments are also innovative:
Embodiment 1 is a method performed by a device having a translation lookaside buffer unit (TBU) configured to map an input translation request to a physical address, wherein the input translation request comprises a virtual address and a stream id, the method comprising:
   mapping, by the TBU, the stream id to a masked stream id of related input translation requests;
   generating a masked translation request comprising the virtual addresses and the masked stream id; and
   servicing the input translation request using the masked translation request.
Embodiment 2 is the method of embodiment 1, wherein the TBU comprises 1) reorder buffering circuitry, and 2) stream id masking circuitry that are configured to operate at least partially in parallel.
Embodiment 3 is the method of embodiment 2, wherein the reorder buffering circuitry and the stream id masking circuitry are configured to operate concurrently for a same input translation request.
Embodiment 4 is the method of any one of embodiment 3, wherein the system comprises a translation control unit (TCU) configured to obtain stream id masks for related streams and to provide the stream id masks or masked stream ids to the TBU.
Embodiment 5 is the method of embodiment 4, wherein the TCU is configured to provide the stream id masks or masked stream ids to the TBU whenever a change to a page table is detected.
Embodiment 6 is the method of any one of embodiments 1-5, wherein the system comprises multiple different processors that provide input translation requests to the TBU, and wherein the related input translation requests originate from a same processor of the multiple different processors.
Embodiment 7 is the method of any one of embodiments 1-6, wherein the TBU is configured to selectively mask input translation requests depending on stream ids of the input translation requests.
Embodiment 8 is the method of any one of embodiments 1-7, wherein multiple different input translation requests are mapped to a same masked translation request.
Embodiment 8 is a system comprising: one or more integrated circuit devices that are to perform the method of any one of embodiments 1 to 8.
Embodiment 9 is a computer storage medium encoded with instructions that are operable, when executed by one or more devices, to cause the devices to perform the method of any one of embodiments 1 to 8.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A system comprising:
a translation lookaside buffer unit (TBU) configured to map an input translation request to a physical address, wherein the input translation request comprises a virtual address and a stream id,
wherein the TBU is configured to map stream ids of related input translation requests to masked stream ids to generate a masked translation requests comprising the virtual address and the masked stream id and to service the input translation request using the masked translation request.

2. The system of claim 1, wherein the TBU comprises reorder buffering circuitry and stream id masking circuitry that are configured to operate at least partially in parallel.

3. The system of claim 2, wherein the reorder buffering circuitry and the stream id masking circuitry are configured to operate concurrently for a same input translation request.

4. The system of claim 3, wherein the system comprises a translation control unit (TCU) configured to obtain stream id masks for related streams and to provide the stream id masks or masked stream ids to the TBU.

5. The system of claim 4, wherein the TCU is configured to provide the stream id masks or masked stream ids to the TBU whenever a change to a page table is detected.

6. The system of claim 1, wherein the system comprises multiple different processors that provide input translation requests to the TBU, and wherein the related input translation requests originate from a same processor of the multiple different processors.

7. The system of claim 1, wherein the TBU is configured to selectively mask input translation requests depending on stream ids of the input translation requests.

8. The system of claim 1, wherein multiple different input translation requests are mapped to a same masked translation request.

9. A method performed by a device having a translation lookaside buffer unit (TBU) configured to map an input translation request to a physical address, wherein the input translation request comprises a virtual address and a stream id, the method comprising:
mapping, by the TBU, the stream id to a masked stream id of related input translation requests;
generating a masked translation request comprising the virtual addresses and the masked stream id; and
servicing the input translation request using the masked translation request.

10. The method of claim 9, wherein the TBU comprises reorder buffering circuitry and stream id masking circuitry that are configured to operate at least partially in parallel.

11. The method of claim 10, wherein the reorder buffering circuitry and the stream id masking circuitry are configured to operate concurrently for a same input translation request.

12. The method of claim 11, wherein the device comprises a translation control unit (TCU) configured to obtain stream id masks for related streams and to provide the stream id masks or masked stream ids to the TBU.

13. The method of claim 12, wherein the TCU is configured to provide the stream id masks or masked stream ids to the TBU whenever a change to a page table is detected.

14. The method of claim 9, wherein the device comprises multiple different processors that provide input translation requests to the TBU, and wherein the related input translation requests originate from a same processor of the multiple different processors.

15. The method of claim 9, wherein the TBU is configured to selectively mask input translation requests depending on stream ids of the input translation requests.

16. The method of claim 9, wherein multiple different input translation requests are mapped to a same masked translation request.

17. A system comprising;
a device having a translation lookaside buffer unit (TBU) configured to map an input translation request to a physical address, wherein the input translation request comprises a virtual address and a stream id; and
one or more storage devices storing instructions that when executed by the device cause the device to perform operations comprising:
mapping, by the TBU, the stream id to a masked stream id of related input translation requests;
generating a masked translation request comprising the virtual addresses and the masked stream id; and
servicing the input translation request using the masked translation request.

18. The system of claim 17, wherein the TBU comprises reorder buffering circuitry and stream id masking circuitry that are configured to operate at least partially in parallel.

19. The system of claim 18, wherein the reorder buffering circuitry and the stream id masking circuitry are configured to operate concurrently for a same input translation request.

20. One or more non-transitory computer-readable storage media storing instructions for a device having a translation lookaside buffer unit (TBU) configured to map an input translation request to a physical address, that when executed by the device causes the device to perform operations comprising:
mapping, by the TBU, a stream id to a masked stream id of related input translation requests, wherein the input translation request comprises a virtual address and the stream id;
generating a masked translation request comprising the virtual addresses and the masked stream id; and
servicing the input translation request using the masked translation request.
